(19) United States
(12) Patent Application Publication
(10) Pub. No.: US 2021/0355015 A1
(43) Pub. Date: Nov. 18, 2021

(54) GLASS FORMING APPARATUSES HAVING INFRARED-TRANSPARENT BARRIERS AND METHODS OF COOLING GLASS USING THE SAME

(71) Applicant: CORNING INCORPORATED, CORNING, NY (US)

(72) Inventors: Tomohiro Aburada, Horseheads, NY (US); Anmol Agrawal, Horseheads, NY (US); Jiandong Meng, Painted Post, NY (US); Gaozhu Peng, Horseheads, NY (US)

(21) Appl. No.: 17/282,252

(22) PCT Filed: Sep. 30, 2019
(86) PCT No.: PCT/US2019/053798

§ 371 Date: Apr. 1, 2021

Related U.S. Application Data
(60) Provisional application No. 62/741,742, filed on Oct. 5, 2018.

(51) Int. Cl. C03B 17/06

(52) U.S. Cl. CPC C03B 17/067; C03B 17/064

(57) ABSTRACT

Embodiments of glass forming apparatuses are disclosed herein. In one embodiment, a glass forming apparatus may include a forming body defining a draw plane extending from the forming body in a draw direction. An actively-cooled thermal sink may be positioned below the forming body in the draw direction and spaced apart from the draw plane. An infrared-transparent barrier may be positioned between the actively-cooled thermal sink and the draw plane. The infrared-transparent barrier may comprise an infrared-transparent wall positioned proximate the actively-cooled thermal sink or an infrared-transparent jacket positioned around the actively-cooled thermal sink.

This application claims the benefit of priority of U.S. Provisional Application Ser. No. 62/741,742 filed on Oct. 5, 2018 the contents of which are relied upon and incorporated herein by reference in their entirety as if fully set forth below.

### FIELD

The present specification generally relates to glass forming apparatuses used in glass manufacturing operations and, in particular, to glass forming apparatuses comprising infrared-transparent barriers that limit a temperature reduction of air within the glass forming apparatuses.

### BACKGROUND

Glass substrates, such as cover glasses, glass backplanes and the like, are commonly employed in both consumer and commercial electronic devices such as LCD and LED displays, computer monitors, automated teller machines (ATMs) and the like. Various manufacturing techniques may be utilized to form molten glass into ribbons of glass which, in turn, are segmented into discrete glass substrates for incorporation into such devices. These manufacturing techniques include, for example and without limitation, down draw processes such as slot draw processes and fusion forming processes, updraw processes, and float processes.

Regardless of the process used, deviations in the width and/or thickness of the glass ribbon may decrease manufacturing through-put and/or increase manufacturing costs as portions of the glass ribbon with deviations in the width and/or thickness are discarded as waste glass.

Accordingly, a need exists for glass forming apparatus and methods for forming glass ribbons which mitigate deviations in the width and/or thickness of the glass ribbon.

### SUMMARY

According to a first aspect A1, a glass forming apparatus may comprise a forming body defining a draw plane extending from the forming body in a draw direction. An actively-cooled thermal sink may be positioned below the forming body in the draw direction and spaced apart from the draw plane. An infrared-transparent barrier positioned between the actively-cooled thermal sink and the draw plane.

A second aspect A2 includes the glass forming apparatus of aspect A1 further comprising a thickness control member positioned below the forming body in the draw direction and a baffle positioned in the draw direction from the actively-cooled thermal sink, wherein the actively-cooled thermal sink and the infrared-transparent barrier are positioned between the thickness control member and the baffle.

A third aspect A3 includes the glass forming apparatus of aspect A2, wherein the baffle extends toward the draw plane.

A fourth aspect A4 includes the glass forming apparatus of any of aspects A2-A3, wherein the thickness control member comprises a slide gate and a cooling door positioned in the draw direction from the slide gate.

A fifth aspect A5 includes the glass forming apparatus of any of aspects A1-A4, wherein the infrared-transparent barrier comprises an infrared-transparent wall positioned between the actively-cooled thermal sink and the draw plane.

A sixth aspect A6 includes the glass forming apparatus of any of aspects A1-A4, wherein the infrared-transparent barrier comprises an infrared-transparent jacket positioned around at least a portion of the actively-cooled thermal sink.

A seventh aspect A7 includes the glass forming apparatus of any of aspects A1-A6, wherein the infrared-transparent barrier comprises a material with an infrared transmittance greater than or equal to 30% at wavelengths from about 0.5 μm to about 6 μm.

An eighth aspect A8 includes the glass forming apparatus of any of aspects A1-A7, wherein the infrared-transparent barrier is spaced apart from the actively-cooled thermal sink.

In a ninth aspect A9, a method of forming a glass ribbon may comprise drawing the glass ribbon from a forming body in a draw direction. The glass ribbon may then cooled by passing the glass ribbon past an actively-cooled thermal sink positioned below the forming body in the draw direction. An infrared-transparent barrier may be positioned between the actively-cooled thermal sink and the draw plane, the infrared-transparent barrier stabilizing eddies of air that circulate adjacent to the glass ribbon.

A tenth aspect A10 includes the method of aspect A9, wherein the eddies of air are stabilized by reducing cooling of air in the eddies of air with the infrared-transparent barrier.

An eleventh aspect A11 includes the method of aspect A9 or aspect A10, wherein the infrared-transparent barrier comprises an infrared-transparent wall positioned between the actively-cooled thermal sink and the glass ribbon.

A twelfth aspect A12 includes the method of aspect A9 or aspect A10, wherein the infrared-transparent barrier comprises an infrared-transparent jacket positioned around at least a portion of the actively-cooled thermal sink.

A thirteenth aspect A13 includes the method of any of aspects A9-A12, wherein the infrared-transparent barrier comprises a material with an infrared transmittance greater than or equal to 30% at wavelengths from about 0.5 μm to about 6 μm.

A fourteenth aspect A14 includes the method of any of aspects A9-A13, wherein the infrared-transparent barrier is spaced apart from the actively-cooled thermal sink.

A fifteenth aspect A15 includes the method of any of aspects A9-A14, wherein the actively-cooled thermal sink is maintained at a temperature less than a temperature of the infrared-transparent barrier.

A sixteenth aspect A16 includes the method of any of aspects A9-A15, wherein: a thickness control member is positioned below the forming body in the draw direction; a baffle is positioned in the draw direction from the actively-cooled thermal sink, wherein the actively-cooled thermal sink and the infrared-transparent barrier are positioned between the thickness control member and the baffle, the baffle and the thickness control member bounding a partially enclosed region; and the eddies of air circulate in the partially enclosed region.

A seventeenth aspect A17 includes the method of aspect A16, wherein the thickness control member comprises a slide gate and a cooling door positioned below the slide gate in the draw direction from the slide gate.

An eighteenth aspect A18 includes the method of aspect A16 or aspect A17, wherein the glass ribbon is in a viscous or a viscoelastic state within the partially enclosed region.

A nineteenth aspect A19 includes the method of any of aspects A16-A18, wherein a temperature variation of air measured at a fixed location in the partially enclosed region is less than 0.4° C. over 10 seconds.

A twentieth aspect A20 includes the method of any of aspects A16-A18, wherein a temperature variation of air measured at a fixed location in the partially enclosed region is less than 0.2° C. over 10 seconds.

It is to be understood that both the foregoing general description and the following detailed description are merely exemplary and are intended to provide an overview or framework to understanding the nature and character of the claimed subject matter. The accompanying drawings are included to provide further understanding and are incorporated in and constitute a part of this specification. The drawings illustrate one or more embodiment(s), and together with the description, explain principles and operation of the various embodiments.

### BRIEF DESCRIPTION OF THE DRAWINGS

FIG. 1 is a schematic view of a glass forming apparatus according to one or more embodiments shown and described herein;

FIG. 2 is a side sectional view of a glass forming apparatus according to one or more embodiments shown and described herein; and

FIG. 3 is a side sectional view of a glass forming apparatus according to one or more embodiments shown and described herein.

### DETAILED DESCRIPTION

Reference will now be made in detail to various embodiments of glass forming apparatuses, examples of which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Unless otherwise expressly stated, it is not intended that any method set forth herein be construed as requiring its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components, plain meaning derived from grammatical organization or punctuation, and the number or type of embodiments described in the specification.

Directional terms as used herein—for example up, down, right, left, front, back, top, bottom—are made only with reference to the figures as drawn and are not intended to imply ab solute orientation.

As used herein, the terms “comprising” and “including,” and variations thereof, shall be construed as synonymous and open ended, unless otherwise indicated.

As used herein, the phrase “actively-cooled thermal sink” refers to an apparatus positioned within an environment at an elevated temperature and that absorbs and removes thermal energy from the environment. The actively-cooled thermal sink incorporates a heat transfer medium that may be controlled to modulate the rate of thermal energy absorbed by the actively-cooled thermal sink.

As used herein, the phrase “infrared-transparent” means the article modified by the term passes at least a portion of infrared radiation incident on the article. For example, an “infrared-transparent” barrier is a barrier wherein at least a portion of the infrared radiation incident on the barrier passes through the barrier rather than being absorbed by and heating the barrier by radiative heat transfer.

As used herein, “viscoelastic state” refers to a physical state of glass in which the viscosity of the glass is from about 1×10⁸ poise to about 1×10¹⁴ poise.

As used herein, “viscous state” refers to a physical state of glass in which the viscosity of the glass is less than the viscosity of the glass in the viscoelastic state, e.g., less than about 1×10⁸ poise.

As used herein, the singular forms “a,” “an” and “the” include plural referents unless the context clearly dictates otherwise. Thus, for example, reference to “a” component includes aspects having two or more such components, unless the context clearly indicates otherwise.

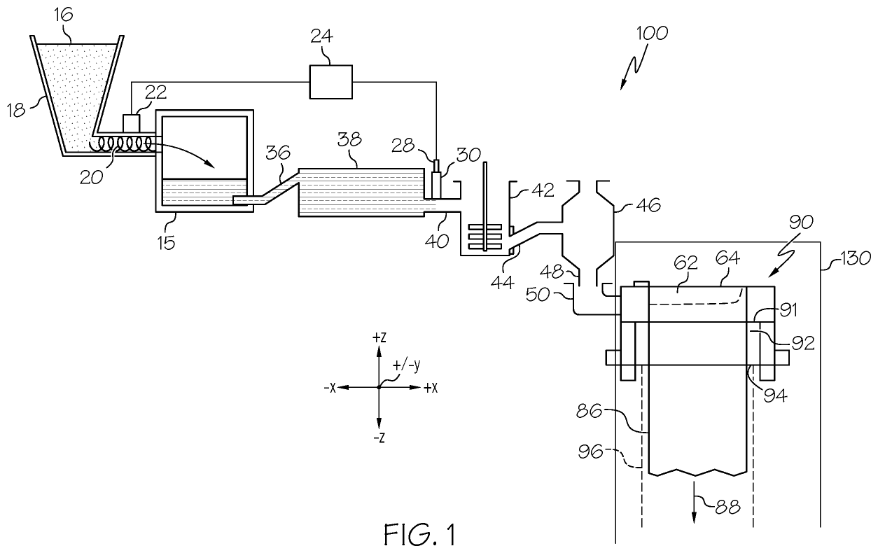

Referring now to FIG. 1, a glass forming apparatus 100 is schematically depicted. As will be described in further detail herein, molten glass flows into and is drawn away from the forming body 90 as a glass ribbon 86. As the glass ribbon 86 is drawn away from the forming body 90, the glass ribbon 86 is cooled and the viscosity of the glass ribbon 86 increases. The increase in viscosity of the glass allows the glass ribbon to sustain pulling forces applied to the glass ribbon to manage the thickness of the glass ribbon. Components of the glass forming apparatus 100 and air that surround the forming body 90 and the glass ribbon 86 regulate the temperature of the molten glass and the glass ribbon 86. Certain glass compositions and/or glass ribbon configurations may have properties that necessitate additional thermal management, such as rapid cooling to decrease the viscosity of the glass ribbon. Cooling the glass ribbon, however, may lead to instabilities in regions within the glass forming apparatus 100 proximate to the glass ribbon 86. For example, non-uniform airflow or non-uniform temperatures of the air in regions within an enclosure 130 surrounding the glass ribbon 86 can lead to variations in the thickness of the glass ribbon and/or the width of the glass ribbon in the cross-draw direction.

For example, elements of the glass forming apparatus that contribute to thermal management may also aid in manufacturing glass at high throughput rates corresponding to an increase in the mass flow rate of molten glass and the corresponding increased thermal load that should be dissipated within a given time to stabilize the glass ribbon as the glass ribbon is drawn from the forming body. The increased thermal load due to higher throughput rates of the glass necessitates increased heat transfer rates from the glass to maintain equivalent temperatures as compared to conventional, lower throughput rates. However, rapid cooling of the glass ribbon disrupts the flow of air with the glass forming apparatus, potentially leading to defects in the glass ribbon.

As will be discussed in greater detail below, the present disclosure is directed to glass forming apparatuses for forming a glass ribbon that comprise infrared-transparent barriers that limit the reduction of the temperature of air in the glass forming apparatus surrounding portions of the glass ribbon. As noted herein, a large amount of thermal energy may be dissipated from the glass ribbon into actively-cooled thermal sinks to cool the molten glass and thereby achieve a target viscosity suitable for sustaining pulling forces. In the embodiments described herein, infrared-transparent barriers prevent the actively-cooled thermal sinks from drawing an undesirably large quantity of heat from air surrounding the glass ribbon. Limiting the temperature loss of the air in the regions surrounding the glass ribbon encourages the formation of stable eddies of air, which, in turn encourages stable cooling of the glass ribbon and mitigates defect formation, such as variations in the thickness and/or width of the glass ribbon.

Specifically, embodiments of the glass forming apparatuses according to the present disclosure comprise actively-cooled thermal sinks positioned to absorb heat from the glass ribbon as the glass ribbon is drawn away from the forming body. Heat from the glass ribbon is dissipated by the actively-cooled thermal sinks, thereby cooling the glass ribbon. Cooling of the glass ribbon may also reduce the temperature of air adjacent to the glass ribbon. Reduction of the temperature of air adjacent to the glass ribbon may be undesirable, as a reduction in the temperature of the air may inhibit formation of stable eddies that circulate between the glass ribbon and the actively-cooled thermal sinks, ultimately resulting in defects in the glass ribbon, such as variations in the width and/or thickness of the glass ribbon. To mitigate such defects, embodiments of the glass forming apparatuses according to the present disclosure also comprise infrared-transparent barriers that maintain a temperature of air positioned between the glass ribbon and the infrared-transparent barriers above the temperature of the actively-cooled thermal sinks, thereby mitigating defects in the glass ribbon, such as undesirable variations in the width and/or thickness of the glass ribbon.

The infrared-transparent barriers aid in stabilizing the eddies of air within the glass forming apparatus. Stable eddies of air are driven by convection. Air proximate to the glass ribbon tends to circulate in an upward direction because the air is hotter and less dense than surrounding air, while air proximate to cooling components, such as cooled walls and/or actively-cooled thermal sinks, may tend to circulate in a downward direction because the air is cooler and more dense than surrounding air. Further reducing the temperature of air adjacent to the glass ribbon, such as by rapidly cooling the glass, may upset the stability of the eddies. For example, cooled air may be too dense to circulate in an upward direction. In such cases, the stability of the eddies within the glass forming apparatus is interrupted, and airflow in regions proximate to the glass ribbon does not flow uniformly. Instability of the airflow in these regions may lead to temperature variation along the glass ribbon, which, in turn, may lead to defects in the glass ribbon, such as thickness variations and/or variations in the width of the glass ribbon in the cross-draw direction. Such defects are caused by irregular or non-uniform cooling of the glass ribbon.

One embodiment of the glass forming apparatuses described herein comprises a forming body defining a draw plane extending in a draw direction. The glass forming apparatus comprises thickness control members spaced apart from the draw plane. The thickness control members are positioned below the root of the forming body in the draw direction. The glass forming apparatus further comprises actively-cooled thermal sinks positioned in the draw direction from the forming body and the thickness control members and spaced apart from the glass ribbon. The glass forming apparatus further comprises infrared-transparent barriers positioned between the actively-cooled thermal sinks and the draw plane. The glass forming apparatus may include baffles positioned in the draw direction from the actively-cooled thermal sinks.

Molten glass is introduced to the forming body and drawn from the forming body as a glass ribbon that travels in a draw direction away from the forming body. The glass ribbon dissipates heat to the actively-cooled thermal sinks. Air in the region proximate to the glass ribbon and the actively-cooled thermal sinks is separated from the actively-cooled thermal sinks by infrared-transparent barriers. The infrared-transparent barriers allow heat from the glass ribbon to dissipate into the actively-cooled thermal sinks but reduce the rate of heat transfer from the air into the actively-cooled thermal sinks. Reducing the rate of heat transfer from air in this region allows the air to form stable eddies that circulate in the region adjacent to the glass ribbon and the actively-cooled thermal sinks, thereby providing stable thermal conditions around the glass ribbon while the glass ribbon cools. This mitigates the occurrence of defects in the glass ribbon, such as variations in the width and/or thickness of the glass ribbon.

While embodiments according to the present disclosure are generally described with respect to a fusion draw process in which a glass ribbon is drawn downward from a forming body, elements of the glass forming apparatus described herein may be incorporated into a variety of glass forming processes, for example, slot forming, updraw, or float processes, without regard to the direction that the glass ribbon is drawn.

Referring now to FIG. 1, an exemplary glass forming apparatus 100 for making glass articles, such as a glass ribbon 86, is schematically depicted. The glass forming apparatus 100 may generally comprise a melting vessel 15 configured to receive batch material 16 from a storage bin 18. The batch material 16 can be introduced to the melting vessel 15 by a batch delivery device 20 powered by a motor 22. An optional controller 24 may be provided to activate the motor 22 and a molten glass level probe 28 can be used to measure the glass melt level within a standpipe 30 and communicate the measured information to the controller 24.

The glass forming apparatus 100 can also comprise a fining vessel 38 coupled to the melting vessel 15 by way of a first connecting tube 36. A mixing vessel 42 is coupled to the fining vessel 38 with a second connecting tube 40. A delivery vessel 46 is coupled to the mixing vessel 42 with a delivery conduit 44. As further illustrated, a downcomer 48 is positioned to deliver molten glass from the delivery vessel 46 to a forming body inlet 50 of a forming body 90. The forming body 90 may be positioned within an enclosure 130. The enclosure 130 may extend in the draw direction 88 (i.e., the downward vertical direction corresponding to the −Z direction in the coordinate axes depicted in the figures). In the embodiments shown and described herein, the forming body 90 is a fusion-forming vessel. Specifically, the forming body 90 has a trough 62 and a pair of opposed weirs 64 (one shown in FIG. 1) bounding the trough 62. A pair of vertical surfaces extend in the downward vertical direction from the pair of weirs 64 to a pair of break lines 91 (one shown in FIG. 1). A pair of opposed converging surfaces 92 (one shown in FIG. 1) extend in the downward vertical direction from the pair of break lines 91 and converge at a root 94 of the forming body 90.

While FIG. 1 depicts a fusion-forming vessel as the forming body 90, other forming bodies are compatible with the methods and apparatuses described herein, including, without limitation, slot-draw forming bodies and the like.

In operation, molten glass from the delivery vessel 46 flows through the downcomer 48, the forming body inlet 50 and into the trough 62. Molten glass in the trough 62 flows over the pair of weirs 64 bounding the trough 62 and down (−Z direction) the pair of converging surfaces 92 converging at the root 94 to form a glass ribbon 86.

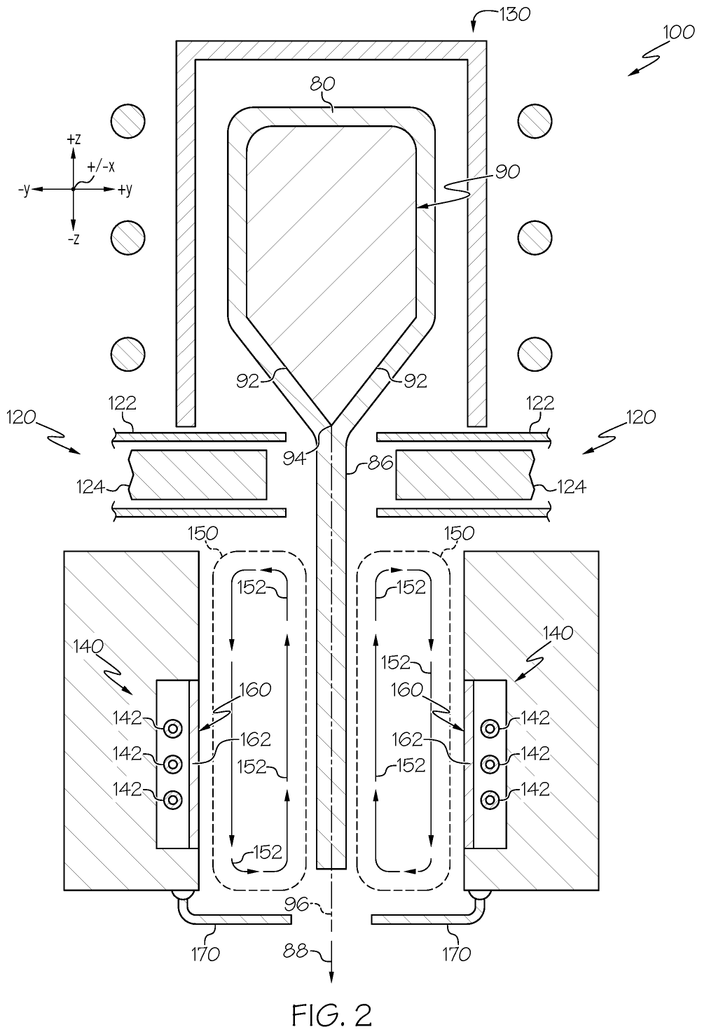

Referring now to FIG. 2, molten glass 80 flows in streams along the converging surfaces 92 of the forming body 90. The streams of molten glass 80 are brought together and fuse below the root 94. The glass is drawn from the forming body 90 in a draw direction 88 as a glass ribbon 86. The forming body 90 defines a draw plane 96 that extends from the root 94 in the draw direction 88. The glass ribbon 86 is drawn from the forming body 90 on the draw plane 96. In the embodiment depicted in FIG. 2, the draw plane 96 is generally parallel to a vertical plane (i.e., parallel to the X-Z plane of the coordinate axes depicted in the figures).

The molten glass 80 increases in viscosity as the molten glass 80 cools from a viscous state to a viscoelastic state and eventually to an elastic state. The viscosity of the glass determines, for example, whether the glass can sustain pulling forces applied to the glass by pulling rollers (not shown) positioned below the root. Glass compositions with relatively low viscosity at temperatures at which the glass is drawn from the forming body 90 may necessitate reduced pulling force that can be sustained by the glass due to the relatively low viscosity. Embodiments according to the present disclosure comprise elements for stabilizing the cooling of the glass ribbon 86 (thereby increasing the viscosity) while mitigating the formation of defects in the glass ribbon, such as variations in the width and/or thickness of the glass ribbon.

Still referring to FIG. 2, the glass forming apparatus 100 further comprises thickness control members 120 extending through the enclosure 130. The thickness control members 120 generally extend parallel to the draw plane 96 in the width direction of the draw plane 96 (i.e., in the +/−X directions of the coordinate axes depicted in the figures) and are spaced apart from the draw plane 96 in directions orthogonal to the draw plane (i.e., in the +/−Y directions of the coordinate axes depicted in the figures). At least a portion of the thickness control members 120 are positioned below the root 94 of the forming body 90 in the draw direction 88. In the embodiment depicted in FIG. 2, the thickness control members 120 comprise slide gates 122 positioned proximate to the root 94 of the forming body 90 and cooling doors 124 positioned in the draw direction 88 from the slide gates 122 (i.e., the cooling doors 124 are positioned below the slide gates 122 in the draw direction 88).

The glass forming apparatus 100 also comprises actively-cooled thermal sinks 140 positioned below the forming body 90 and below the thickness control members 120 in the draw direction 88. The glass forming apparatus 100 also comprises baffles 170 positioned below the actively-cooled thermal sinks 140 in the draw direction 88. During steady state operation of the glass forming apparatus 100, the baffles 170 are extended toward the draw plane 96 thereby forming partially enclosed regions 150 along the draw plane 96 between the thickness control members 120 and the baffles 170. The baffles 170 (when extended toward the draw plane 96) facilitate establishing stable eddies of air in the partially enclosed regions 150 bounded on two sides by the baffles 170 and the thickness control members 120. The baffles 170 also act as radiation shields to prevent components of the glass forming apparatus 100 that are positioned in the draw direction 88 from the baffles 170 from being heated. In various embodiments, the baffles 170 are hingedly attached within the glass forming apparatus 100, such that the baffles 170 can be pivoted away from the draw plane 96. For example, the baffles 170 may be pivoted away from the draw plane 96 during start-up of the glass forming apparatus 100 to allow the glass ribbon 86 to be threaded through the glass forming apparatus 100 along the draw plane 96. Thereafter, the baffles 170 may be pivoted toward the draw plane 96 once steady-state operation of the glass forming apparatus 100 is achieved.

The thickness control members 120, the actively-cooled thermal sinks 140, and the baffles 170 extend along the width of the glass ribbon 86, which is at an orientation that is perpendicular to the view shown in FIG. 2 (i.e., the width of the glass ribbon extends in the +/−X direction of the coordinate axes depicted in the figures). The thickness control members 120, the actively-cooled thermal sinks 140, and the baffles 170 are spaced apart from the draw plane 96 such that these elements do not contact either the molten glass 80 or the glass ribbon 86.

In embodiments, the actively-cooled thermal sinks 140 incorporate active cooling elements, for example, a fluid conduit 142, that generally extends parallel to a width of the glass ribbon 86. The actively-cooled thermal sink 140 may comprise a cooling fluid that flows through the fluid conduit 142. The cooling fluid controls the temperature of the fluid conduit 142, and heat from the glass ribbon 86 may be dissipated into the cooling fluid. By flowing the cooling fluid out of the fluid conduit 142, heat can be removed from the glass forming apparatus 100. Specifically, heat from the glass ribbon 86 heats the cooling fluid in the fluid conduit 142 and the cooling fluid carries the heat out of the glass forming apparatus 100 as it flows through the fluid conduit 142.

In some embodiments, the cooling fluid directed through the fluid conduits 142 and the flow rate of the cooling fluid can be selected based on the thermal properties of the cooling fluid as well as the amount of heat that is to be dissipated from the glass forming apparatus 100. In general, cooling fluids may be selected based on the heat capacity of the cooling fluids. In general, liquid cooling fluids may be preferred, as the density of the liquid tends to result in high thermal capacity. Examples of acceptable cooling fluids include, for illustration and not limitation, air, water, nitrogen, water vapor, or a commercially available refrigerant. In some embodiments, the cooling fluid and the flow rate of the cooling fluid may be selected such that the cooling fluid does not undergo a phase change when passing through the fluid conduit. In some embodiments, the cooling fluid may be cycled through the fluid conduits 142 and through a cooling system (not shown) to maintain the temperature of the fluid in a closed loop system. In other embodiments, the fluid may be discharged after passing through the fluid conduits 142.

Still referring to FIG. 2, the glass forming apparatus 100 further comprises infrared-transparent barriers 160 positioned between the actively-cooled thermal sinks 140 and the draw plane 96. In the embodiment depicted in FIG. 2, the infrared-transparent barriers 160 are infrared-transparent walls 162 positioned between the draw plane 96 and the actively-cooled thermal sinks 140. The infrared-transparent barriers 160 allow at least a portion of the infrared radiation incident on the barrier to pass through or partially pass through the infrared-transparent barrier 160. Specifically, the infrared-transparent barrier 160 may allow thermal energy from radiation heat transfer to pass while interrupting the flow of energy due to, for example, conduction or convection heat transfer.

The infrared-transparent barriers 160 may be made from materials having an infrared transmittance of greater than or equal to 30% for wavelengths of infrared radiation from about 0.5 micrometers (μm) to about 6 μm incident on the barrier. Such materials may exhibit an infrared-transmittance that is greater than or equal to 40%, greater than or equal to 50%, or even greater than or equal to 60%. Examples of such materials comprise, for illustration and not limitation, transparent β-SiC, high-purity fused silica, infrared-transparent mullite ceramics, and glass ceramics, such as KeraBlack® produced by Eurokera.

The infrared-transparent walls 162 are spaced apart from the actively-cooled thermal sinks 140 such that there is limited conductive and convective heat transfer between the actively-cooled thermal sinks 140 and the infrared-transparent walls 162. Limited conductive and convective heat transfer between the actively-cooled thermal sinks 140 and the infrared-transparent walls 162 allows the actively-cooled thermal sinks 140 and the infrared-transparent walls 162 to be maintained at different temperatures during operation of the glass forming apparatus 100. However, heat in the form of thermal radiation continues to be transmitted through the infrared-transparent walls 162 to the actively-cooled thermal sinks 140.

As noted herein, the thickness control members 120 and the baffles 170 define partially enclosed regions 150 of the glass forming apparatus 100 that are proximate to the draw plane 96. When glass is being produced in the glass forming apparatus 100, the glass ribbon 86 is drawn from the forming body 90 and past the thickness control members 120, the actively-cooled thermal sinks 140, and the baffles 170. The glass ribbon 86 is at a higher temperature than the actively-cooled thermal sinks 140. Accordingly, heat from the glass ribbon 86 is dissipated into the actively-cooled thermal sinks 140 by radiation heat transfer and carried away by the cooling fluid of the fluid conduits 142. Because of the large temperature differential between the glass ribbon 86 and the actively-cooled thermal sinks 140, substantial heat can be dissipated from the glass ribbon 86 in a short distance along the draw direction 88. Dissipating a large amount of heat may be beneficial for glass manufacturing operations in which a rapid decrease in temperature of the glass ribbon 86 is targeted.

In the embodiments described herein, eddies 152 of air (i.e., circulating currents of air) form within the partially enclosed regions 150 between the thickness control members 120 and the baffles 170. Air positioned proximate to the glass ribbon 86 is generally hotter than air positioned farther from the glass ribbon 86, such as air adjacent to the actively-cooled thermal sinks 140. The variation in the temperature of the air corresponds to a variation in the density of the air, with the warmer air having a lower density and therefore more buoyancy than the cooler air. The warmer, lower density air tends to circulate in an upward direction (opposite the direction of gravity) while the cooler, higher density air tends to circulate in a downward direction (following the direction of gravity). In embodiment depicted in FIG. 2, the draw direction 88 is generally the direction of gravity, but the draw direction may vary from the direction of gravity based on particular glass forming methods.

The eddies 152 of air that circulate within the partially enclosed region 150 are driven by convection. Instability in the convection that drives the eddies 152 may cause an undesirable variation in the temperature of the glass ribbon 86. Specifically, variations in the temperature of the glass ribbon 86 correspond to variations in the viscosity of the glass ribbon 86. Such variations in viscosity are undesirable, particularly when the glass is in a viscous or viscoelastic state. Variations in the viscosity of the glass ribbon 86 in such states may make it difficult to maintain the thickness of the glass ribbon 86 and/or the width of the glass ribbon 86 as it is drawn from the forming body 90. Accordingly, instability of the eddies 152 of air that circulate within the partially enclosed regions 150 are undesired.

Without being bound by theory, it is believed that a large differential in temperature between the glass ribbon 86 and the surfaces of the glass forming apparatus 100 that surround the glass ribbon 86, as well as the air that surrounds the glass ribbon 86, introduces greater instability in the eddies 152. By positioning the infrared-transparent barriers 160 between the actively-cooled thermal sinks 140 and the glass ribbon 86, the temperature differential between the glass ribbon 86 and surfaces of the glass forming apparatus 100 and air within the glass forming apparatus 100 can be reduced, thereby increasing the stability of the eddies 152 within the partially enclosed regions 150 and improving the stability of the glass manufacturing process.

In particular, the infrared-transparent walls 162 allow for substantial amounts of heat to be dissipated from the glass ribbon 86 into the actively-cooled thermal sinks 140 without substantially cooling the air of the eddies 152. By spacing the air in the eddies 152 from the actively-cooled thermal sinks 140, temperature reduction of the air in the eddies 152 can be mitigated. Accordingly, the air of the eddies 152 at positions proximate to the infrared-transparent walls 162 can be maintained at a relatively higher temperature as compared to the temperature of the actively-cooled thermal sinks 140. Maintaining an elevated temperature of the air in the eddies 152 improves stability of the eddies 152 that circulate within the partially enclosed regions 150, improving the stability of the glass manufacturing process and reducing or mitigating the formation of defects in the glass ribbon, such as variations in the width and/or thickness of the glass ribbon.

In the embodiments described herein, stability of the eddies 152 may be determined by measuring the temperature of the air in the partially enclosed regions 150. A stable eddy 152 exhibits a peak-to-peak temperature variation of air measured at a fixed location in the partially enclosed region 150 of less than or equal to 0.4° C. over a time of 10 seconds. In some embodiments, the peak-to-peak temperature variation of air measured at a fixed location in the partially enclosed region 150 is less than or equal to 0.2° C. over a time of ten seconds. In some embodiments, the peak-to-peak temperature variation of air measured at a fixed location in the partially enclosed region 150 is less than or equal to 0.1° C. over a time of 10 seconds.

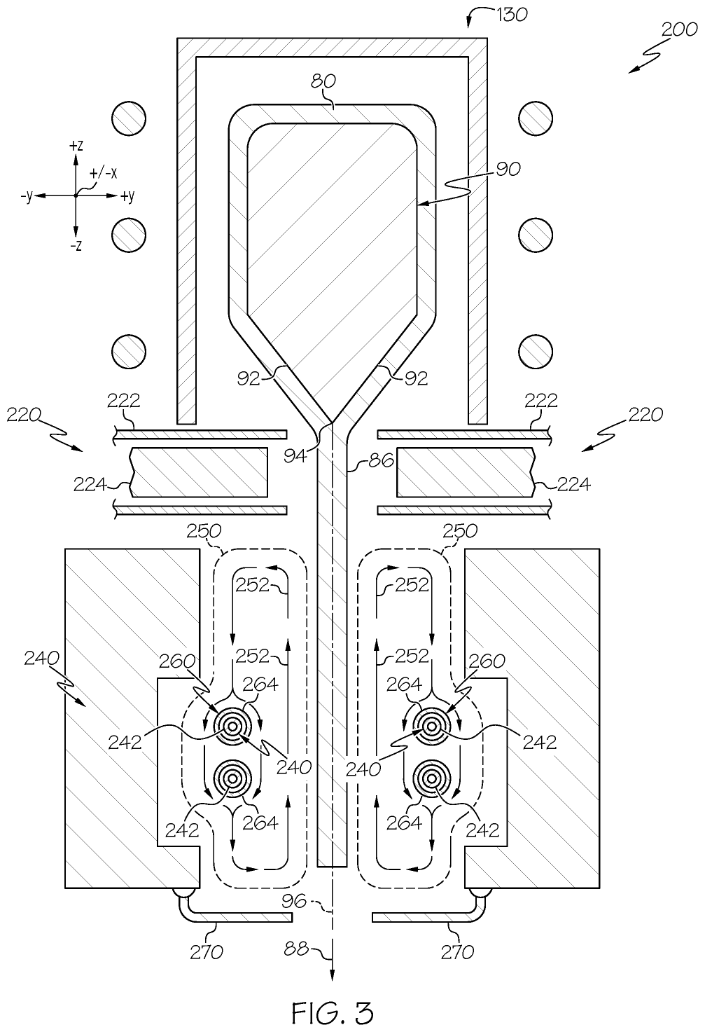

Referring now to FIG. 3, another embodiment of a glass forming apparatus 200 is schematically depicted. In this embodiment, the glass forming apparatus 200 includes a forming body 90 positioned within an enclosure 130 as described hereinabove with respect to FIGS. 1 and 2. The forming body 90 may comprise converging surfaces 92 that terminate at a root 94. Molten glass 80 flows in streams along the converging surfaces 92 of the forming body 90. The streams of molten glass 80 are brought together and fuse below the root 94. The glass is drawn from the forming body 90 in a draw direction 88 along draw plane 96 as a glass ribbon 86, as described hereinabove with respect to FIGS. 1 and 2.

Still referring to FIG. 3, the glass forming apparatus 200 further comprises thickness control members 220 extending through the enclosure 130, as described herein with respect to FIG. 2. The thickness control members 220 generally extend parallel to the draw plane 96 in the width direction of the draw plane 96 (i.e., in the +/−X directions of the coordinate axes depicted in the figures) and are spaced apart from the draw plane 96 in directions orthogonal to the draw plane (i.e., in the +/−Y directions of the coordinate axes depicted in the figures). At least a portion of the thickness control members 220 are positioned below the root 94 of the forming body 90 in the draw direction 88. In the embodiment depicted in FIG. 3, the thickness control members 220 comprise slide gates 222 positioned proximate to the root 94 of the forming body 90 and cooling doors 224 positioned in the draw direction 88 from the slide gates 222 (i.e., the cooling doors 224 are positioned downstream of the slide gates 222 in the draw direction 88).

The glass forming apparatus 200 also comprises actively-cooled thermal sinks 240 positioned below the forming body 90 and below the thickness control members 220 in the draw direction 88. The glass forming apparatus 200 also comprises baffles 270 positioned below the actively-cooled thermal sinks 240 in the draw direction 88. During steady state operation of the glass forming apparatus 200, the baffles 270 are extended toward the draw plane 96 thereby forming partially enclosed regions 250 along the draw plane 96 bounded on two sides by the thickness control members 220 and the baffles 270. The baffles 270 (when extended toward the draw plane 96) facilitate establishing stable eddies of air in the partially enclosed regions 250 between the baffles 270 and the thickness control members 220. The baffles 270 also act as radiation shields to prevent components of the glass forming apparatus 200 that are positioned in the draw direction 88 from the baffles 270 from being heated. In various embodiments, the baffles 270 are hingedly attached within the glass forming apparatus 200, such that the baffles 270 can be pivoted away from the draw plane 96. For example, the baffles 270 may be pivoted away from the draw plane 96 during start-up of the glass forming apparatus 200 to allow the glass ribbon 86 to be threaded through the glass forming apparatus 200 along the draw plane 96. Thereafter, the baffles 270 may be pivoted toward the draw plane 96 once steady-state operation of the glass forming apparatus 200 is achieved.

The thickness control members 220, the actively-cooled thermal sinks 240, and the baffles 270 extend along the width of the glass ribbon 86, which is at an orientation perpendicular to the view shown in FIG. 3 (i.e., the width of the glass ribbon extends in the +/−X direction of the coordinate axes depicted in the figures). The thickness control members 220, the actively-cooled thermal sinks 240, and the baffles 270 are spaced apart from the draw plane 96 such that these elements do not contact either the molten glass 80 or the glass ribbon 86.

In embodiments, the actively-cooled thermal sinks 240 incorporate active cooling elements, for example, a fluid conduit 242, that generally extends parallel to a width of the glass ribbon 86, as described herein with respect to FIG. 2. The actively-cooled thermal sink 240 may comprise a cooling fluid that flows through the fluid conduit 242. The cooling fluid controls the temperature of the fluid conduit 242, and heat from the glass ribbon 86 may be dissipated into the cooling fluid. By flowing the cooling fluid out of the fluid conduit 242, heat can be removed from the glass forming apparatus 200. Specifically, heat from the glass ribbon 86 heats the cooling fluid in the fluid conduit 242 and the cooling fluid carries the heat out of the glass forming apparatus 200 as it flows through the fluid conduit 242.

The glass forming apparatus 200 further comprises infrared-transparent barriers 260 positioned between the actively-cooled thermal sinks 240 and the draw plane 96. In the embodiment depicted in FIG. 3, the infrared-transparent barriers 260 are infrared-transparent jackets 264 positioned around a least a portion of the actively-cooled thermal sinks 240 such that the infrared-transparent jackets 264 are positioned between the actively-cooled thermal sinks 240 and the draw plane 96. The infrared-transparent jackets 264 may be constructed from the same materials and have the same infrared transmittance as the infrared-transparent walls described herein with respect to FIG. 2. For example, the infrared-transparent jackets 264 may be made from materials having an infrared transmittance of greater than or equal to 30% for wavelengths of infrared radiation from about 0.5 micrometers (μm) to about 6 μm incident on the barrier. Such materials may exhibit an infrared-transmittance that is greater than or equal to 40%, greater than or equal to 50%, or even greater than or equal to 60%. Examples of such materials comprise, for illustration and not limitation, transparent β-SiC, high-purity fused silica, infrared-transparent mullite ceramics, and glass ceramics, such as KeraBlack® produced by Eurokera.

In the embodiments described herein, the infrared-transparent jackets 264 can be spaced apart from the actively-cooled thermal sinks 240 such that there is limited conductive and convective heat transfer between the actively-cooled thermal sinks 240 and the infrared-transparent jackets 264. Limited conductive and convective heat transfer between the actively-cooled thermal sinks 240 and the infrared-transparent jackets 264 allows the actively-cooled thermal sinks 240 and the infrared-transparent jackets 264 to be maintained at different temperatures during operation of the glass forming apparatus 200. However, heat in the form of thermal radiation continues to be transmitted through the infrared-transparent jackets 264 to the actively-cooled thermal sinks 140.

As noted herein, the thickness control members 220 and the baffles 270 define partially enclosed regions 250 of the glass forming apparatus 200 that are proximate to the draw plane 96. When glass is being produced in the glass forming apparatus 200, the glass ribbon 86 is drawn from the forming body 90 and past the thickness control members 220, the actively-cooled thermal sinks 240, and the baffles 270. The glass ribbon 86 is at a higher temperature than the actively-cooled thermal sinks 240. Accordingly, heat from the glass ribbon 86 is dissipated into the actively-cooled thermal sinks 240 by radiation heat transfer and carried away by the cooling fluid of the fluid conduits 242. Because of the large temperature differential between the glass ribbon 86 and the actively-cooled thermal sinks 240, substantial heat can be dissipated from the glass ribbon 86 in a short distance along the draw direction 88. Dissipating a large amount of heat may be beneficial for glass manufacturing operations in which a rapid decrease in temperature of the glass ribbon 86 is targeted.

As described herein with respect to FIG. 2, eddies 252 of air (i.e., circulating currents of air) form within the partially enclosed regions 250 between the thickness control members 220 and the baffles 270. Air positioned proximate to the glass ribbon 86 is generally hotter than air positioned farther from the glass ribbon 86. The variation in temperature of the air corresponds to a variation in the density of the air, with the warmer air having a lower density and therefore more buoyancy than the cooler air. The warmer, lower density air tends to circulate in an upward direction (opposite the direction of gravity) while the cooler, higher density air tends to circulate in a downward direction (following the direction of gravity). In the depicted embodiment, the draw direction 88 is generally the direction of gravity, but the draw direction may vary from the direction of gravity based on particular glass forming methods.

The eddies 252 of air that circulate within the partially enclosed region 250 are driven by convection. Instability in the convection that drives the eddies 252 may cause an undesirable variation in the temperature of the glass ribbon 86. Specifically, variations in the temperature of the glass ribbon 86 correspond to variations in the viscosity of the glass ribbon 86. Such variations in viscosity are undesirable, particularly when the glass is in a viscous or viscoelastic state. Variations in the viscosity of the glass ribbon 86 in such states may make it difficult to maintain the thickness of the glass ribbon 86 and/or the width of the glass ribbon 86 as it is drawn from the forming body 90. Accordingly, instability of the eddies 252 of air that circulate within the partially enclosed regions 250 are undesired.

Without being bound by theory, it is believed that a large differential in temperature between the glass ribbon 86 and the surfaces of the glass forming apparatus 200 that surround the glass ribbon 86, as well as the air that surrounds the glass ribbon 86, introduces greater instability in the eddies 252. By positioning the infrared-transparent jackets 264 between the actively-cooled thermal sinks 240 and the glass ribbon 86, the temperature differential between the glass ribbon 86 and surfaces of the glass forming apparatus 200 and air within the glass forming apparatus 200 can be reduced, thereby increasing the stability of the eddies 252 within the partially enclosed regions 250 and improving the stability of the glass manufacturing process.

The infrared-transparent jackets 264 can allow for substantial amounts of heat to be dissipated from the glass ribbon 86 into the actively-cooled thermal sinks 240 without substantially cooling the air of the eddies 252. By spacing the air in the eddies 252 from the actively-cooled thermal sinks 240, temperature reduction of the air in the eddies 252 can be mitigated. Accordingly, the air of the eddies 252 at positions proximate to the infrared-transparent jackets 264 can be maintained at an elevated temperature as compared to the temperature of the actively-cooled thermal sinks 240. Maintaining an elevated temperature of the air in the eddies 252 improves stability of the eddies 252 that circulate within the partially enclosed regions 250, improving the stability of the glass manufacturing process and reducing or mitigating the formation of defects in the glass ribbon, such as variations in the width and/or thickness of the glass ribbon.

As noted herein with respect to FIG. 2, stability of the eddies 252 may be determined by measuring the temperature of the air in the partially enclosed regions 250. A stable eddy 252 exhibits a peak-to-peak temperature variation of air measured at a fixed location in the partially enclosed region 250 of less than or equal to 0.4° C. over a time of 10 seconds. In some embodiments, the peak-to-peak temperature variation of air measured at a fixed location in the partially enclosed region 250 is less than or equal to 0.2° C. over a time of ten seconds. In some embodiments, the peak-to-peak temperature variation of air measured at a fixed location in the partially enclosed region 250 is less than or equal to 0.1° C. over a time of 10 seconds.

It should now be understood that glass forming apparatuses according to the present disclosure include a forming body actively-cooled thermal sinks, and infrared-transparent barriers positioned between the actively-cooled thermal sinks and the draw plane defined by the forming body. The glass forming apparatus produces a glass ribbon that is drawn past the actively-cooled thermal sinks. The infrared-transparent barriers allow heat in the form of thermal radiation to pass through the infrared-transparent barriers, such that heat from the glass ribbon is dissipated to the actively-cooled thermal sinks. Additionally, the infrared-transparent barriers separate the air positioned proximate to the glass ribbon from the actively-cooled thermal sinks such that the air positioned proximate to the infrared-transparent barriers is at a higher temperature than the actively-cooled thermal sinks. Maintaining the air at a higher temperature than the actively-cooled thermal sinks increases the stability of eddies that circulate adjacent to the glass ribbon drawn on the draw plane and mitigates the occurrence of defects in the glass ribbon, such as variations in the width and/or thickness of the glass ribbon.

It will be apparent to those skilled in the art that various modifications and alterations can be made to the present disclosure without departing from the scope and spirit of the disclosure. Thus, it is intended that the present disclosure cover the modifications and variations of embodiments disclosed herein provided they come within the scope of the appended claims and their equivalents.

What is claimed is:

1. A glass forming apparatus, comprising:
a forming body defining a draw plane extending from the forming body in a draw direction;
an actively-cooled thermal sink positioned below the forming body in the draw direction and spaced apart from the draw plane; and
an infrared-transparent barrier positioned between the actively-cooled thermal sink and the draw plane.

2. The glass forming apparatus of claim 1, further comprising:
a thickness control member positioned below the forming body in the draw direction; and
a baffle positioned in the draw direction from the actively-cooled thermal sink, the actively-cooled thermal sink and the infrared-transparent barrier positioned between the thickness control member and the baffle.

3. The glass forming apparatus of claim 2, wherein the baffle extends toward the draw plane.

4. The glass forming apparatus of claim 2, wherein the thickness control member comprises a slide gate and a cooling door positioned in the draw direction from the slide gate.

5. The glass forming apparatus of claim 1, wherein the infrared-transparent barrier comprises an infrared-transparent wall positioned between the actively-cooled thermal sink and the draw plane.

6. The glass forming apparatus of claim 1, wherein the infrared-transparent barrier comprises an infrared-transparent jacket positioned around at least a portion of the actively-cooled thermal sink.

7. The glass forming apparatus of claim 1, wherein the infrared-transparent barrier comprises a material with an infrared transmittance greater than or equal to 30% at wavelengths from about 0.5 μm to about 6 μm.

8. The glass forming apparatus of claim 1, wherein the infrared-transparent barrier is spaced apart from the actively-cooled thermal sink.

9. A method of forming a glass ribbon comprising:
drawing the glass ribbon from a forming body in a draw direction;
cooling the glass ribbon by passing the glass ribbon past an actively-cooled thermal sink positioned below the forming body in the draw direction, an infrared-transparent barrier positioned between the actively-cooled thermal sink and the draw plane; and
stabilizing eddies of air that circulate adjacent to the glass ribbon.

10. The method of claim 9, wherein the eddies of air are stabilized by reducing cooling of air in the eddies of air with the infrared-transparent barrier.

11. The method of claim 9, wherein the infrared-transparent barrier comprises an infrared-transparent wall positioned between the actively-cooled thermal sink and the glass ribbon.

12. The method of claim 9, wherein the infrared-transparent barrier comprises an infrared-transparent jacket positioned around at least a portion of the actively-cooled thermal sink.

13. The method of claim 9, wherein the infrared-transparent barrier comprises a material with an infrared transmittance greater than or equal to 30% at wavelengths from about 0.5 μm to about 6 μm.

14. The method of claim 9, wherein the infrared-transparent barrier is spaced apart from the actively-cooled thermal sink.

15. The method of claim 9, wherein the actively-cooled thermal sink is maintained at a temperature less than a temperature of the infrared-transparent barrier.

16. The method of claim 9, wherein:
a thickness control member is positioned below the forming body in the draw direction;
a baffle is positioned in the draw direction from the actively-cooled thermal sink, the actively-cooled thermal sink and the infrared-transparent barrier positioned between the thickness control member and the baffle, the baffle and the thickness control member bounding a partially enclosed region; and
the eddies of air circulate in the partially enclosed region.

17. The method of claim 16, wherein the thickness control member comprises a slide gate and a cooling door positioned below the slide gate in the draw direction from the slide gate.

18. The method of claim 16, wherein the glass ribbon is in a viscous or a viscoelastic state within the partially enclosed region.

19. The method of claim 16, wherein a temperature variation of air measured at a fixed location in the partially enclosed region is less than 0.4° C. over 10 seconds.

20. The method of claim 16, wherein a temperature variation of air measured at a fixed location in the partially enclosed region is less than 0.2° C. over 10 seconds.
